(19) United States
(12) Patent Application Publication
(10) Pub. No.: US 2025/0242783 A1
(43) Pub. Date: Jul. 31, 2025

(54) INTERIOR WINDSHIELD WIPER WITH WATER VAPOR PUMP

(71) Applicant: KING FAISAL UNIVERSITY, AL-AHSA (SA)

(72) Inventor: ABDELRAHIM FATHY ISMAIL, AL-AHSA (SA)

(21) Appl. No.: 18/428,335

(22) Filed: Jan. 31, 2024

(51) Int. Cl. B60S 1/52; B60S 1/04; B60S 1/44; B60S 1/48

(52) U.S. Cl. CPC B60S 1/524; B60S 1/0452; B60S 1/487; B60S 1/44

(57) ABSTRACT

An interior windshield wiper system includes a water tank and a heater located within the water tank. The heater heats contents of the water tank. A conduit leads from the water tank to an interior surface of a vehicle. Apertures are located at an end of the conduit proximal to the interior surface, wherein the contents of the water tank travel though the conduit and apertures and onto the interior surface of the vehicle, such as a windshield. A wiper is located proximal to the interior surface to wipe the interior surface.

### BACKGROUND

### 1. Field

The present disclosure relates to systems that clear a windshield of a vehicle, and particularly to system that clears the inner windshield of a vehicle.

### 2. Description of the Related Art

Car drivers suffer from blurred vision due to the presence of dust and fog on a car's windshield. There are windshield wipers that clear the outside of a car's windshield to improve visibility. However, on rainy days, days with high humidity, or cold days, the inside of a vehicle's windshield may also have low visibility.

### SUMMARY

There is a need for a vehicle to have windshield wipers that operate on the inside of a windshield. A water vapor maker is integrated in the vehicle's windshield wipers, so that water vapor is pumped out when the wipers are turned on. The water vapor maker includes a water tank, a steam generator and a pump. The water in the tank is heated when the vehicle's wipers are operated to clear the inside portion of the windshield. The wipers spread water vapor on the glass and then a wiper arm moves to clean the inside of the glass.

An interior windshield wiper system, in one embodiment, includes a water tank and a heater located within the water tank. The heater heats the contents of the water tank. A conduit leads from the water tank to an interior surface of a vehicle. Apertures are located at an end of the conduit proximal to the interior surface, wherein the contents of the water tank travel though the conduit and apertures and onto the interior surface. A wiper is located proximal to the interior surface to wipe the interior surface.

The interior surface can be an interior windshield of a vehicle.

The apertures are part of the wiper in some embodiments.

The wiper can be configured to move horizontally across the interior surface, vertically across the interior surface, in an arc path across the interior surface, in a circular pattern across the interior surface, or a combination thereof.

A method to wipe an interior surface of a vehicle includes heating contents of a water tank with a heater to create water vapor; pumping the water vapor through a conduit and apertures onto an interior surface of a vehicle; and wiping the vapor dispersed through the apertures onto the interior surface with a wiper.

The interior surface can be a windshield.

The apertures can be a part of the wiper.

The wiper can move horizontally across the interior surface, vertically across the interior surface, in an arc path across the interior surface, in a circular pattern across the interior surface, or a combination thereof.

These and other features of the present subject matter will become readily apparent upon further review of the following specification.

### BRIEF DESCRIPTION OF THE DRAWINGS

FIG. 1 is an illustration of an interior windshield wiper system.

FIG. 2 is an illustration of an interior windshield wiper moving in a horizontal direction across the interior of a windshield of a car.

Similar reference characters denote corresponding features consistently throughout the attached drawings.

### DETAILED DESCRIPTION OF THE PREFERRED EMBODIMENTS

An interior windshield wiper system of a vehicle, such as a car, includes an integrated water vapor generator to generate steam or water vapor that assists in removing dust and fog on the inside of a windshield. The system includes a water vapor generator that pumps water vapor out of the wipers when the wipers are turned on, such that wipers spread water vapor on the glass and then the wiper arms move to remove the water vapor and clean the glass.

The water vapor generator includes a water tank, a heater, a power source, and a pump. The water in the water tank is heated when the car's interior wipers are operated from the inside of the vehicle.

The water tank and the heater are placed anywhere inside the vehicle body and are accessible to the wiper arms and the power source.

The wiper arms are designed to move in a variety of ways, such as back and forth in a horizontal or vertical direction, in a circular motion, or in a combination thereof.

The water tank is filled manually or automatically, such as through a connection to the car's cooling system.

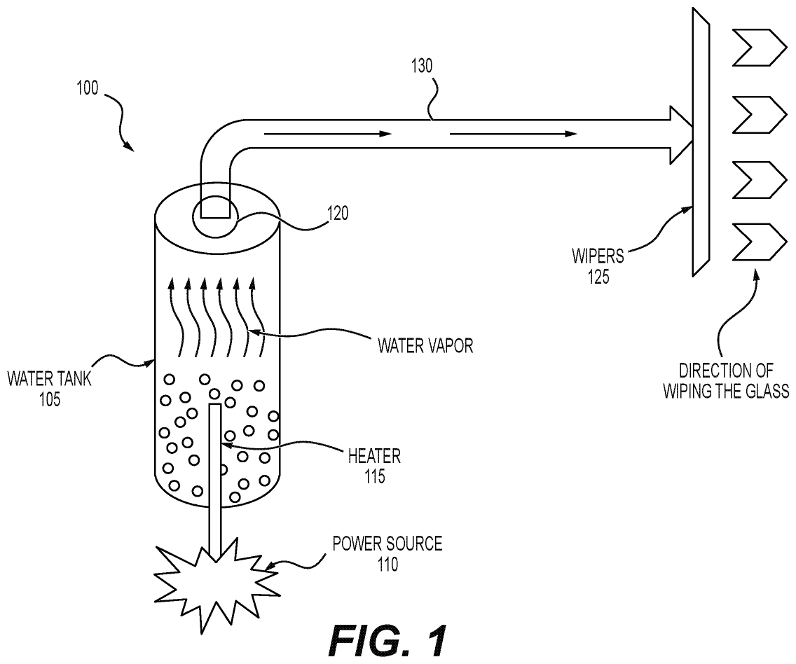

FIG. 1 is an illustration of an interior windshield wiper system 100. It includes a water tank 105 and a power source 110. A heater 115 is powered by the power source 110 to heat water in the water tank 105. The heated water turns into steam or water vapor and a pump 120, also powered by power source 110, pumps the water vapor to the wipers 125 through a conduit 130.

The water tank 105, heater 115 and pump 120 can be located anywhere inside a vehicle's body. The conduit 130 leads to wipers 125 located at an interior of the windshield of the vehicle. The heater 115 heats water in the water tank 105 creating water vapor and the pump 120 pumps the vapor through the conduit 120 to the wipers 125.

The wipers 125 include small apertures allowing the water vapor being pumped through the conduit 120 to be sprayed onto the inside of the windshield of the vehicle. The wipers 125 can move vertically, horizontally or in circles depending on needs. In some cases the wipers can move in multiple directions. The wipers 125 can also be positioned on the inside of other windows of the vehicle, such as for example, side windows or rear windows.

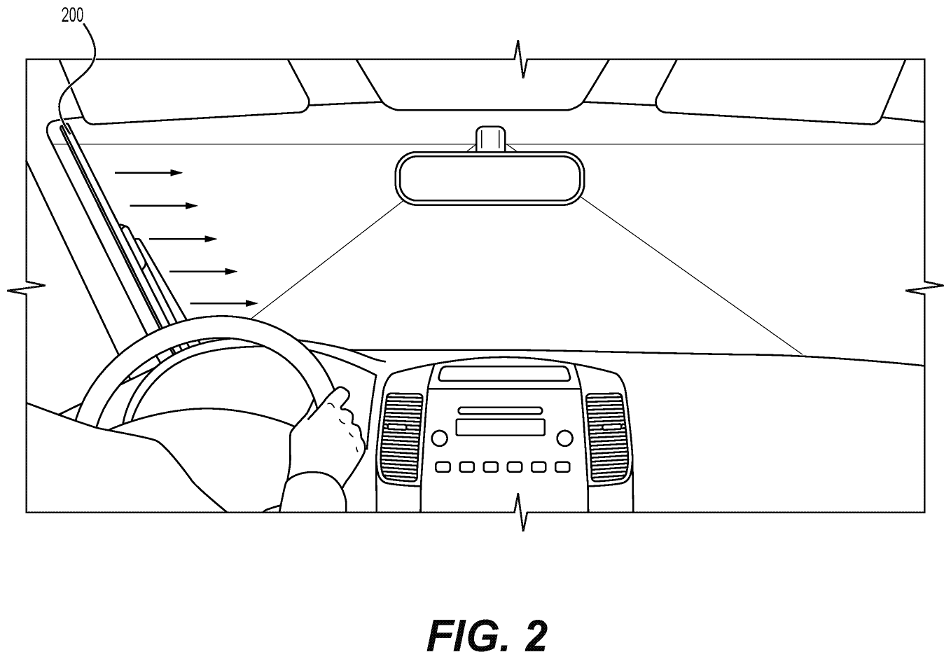

FIG. 2 is an illustration of an interior windshield wiper 200 moving in a horizontal direction across the interior of a windshield of a car. Water vapor is sprayed through the windshield wiper 200 to assist in cleaning the interior of the windshield.

The current innovation incorporates a water vapor generator designed to supply steam to the interior windshield wipers. This enables the wiping of the vehicle's interior windshield in horizontal, vertical, circular motions, arc path or a combination thereof. Positioned within the car body, in one embodiment adjacent to the engine, the water vapor generator includes a water tank, a power source, and a pump to propel water vapor into interior spaces through appropriate connectors. The wipers then disperse the water vapor onto the glass from the inside, effectively eliminating fog or dust.

Embodiments of the interior windshield wiping system include a water vapor generator and pump for the interior windshield wipers. Moreover, the water vapor generator utilizes a compact water tank and a car body-installed water heater connected to a power source.

It is to be understood that the present subject matter is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An interior windshield wiper system, comprising:
a water vapor generator positioned within a body of a car, adjacent to an engine of the car, said water vapor generator including:
a water tank having an interior storage area, the interior storage area having a first portion thereof configured to store water therein and a second portion thereof configured to be free of water and to store water vapor therein;
a power source, and
a pump;
a heater located in the first portion of the interior storage area of the water tank, the heater being configured to heat the water in the first portion of the interior storage area of the water tank to form water vapor, the formed water vapor being stored in the second portion of the interior storage area of the water tank, wherein the power source is configured to power the heater;
a wiper located proximal to an interior windshield surface of the car, the wiper being configured to wipe fog or dust from the interior windshield surface; and
a conduit having an inlet opening in fluid communication with the second portion of the interior storage area of the water tank, an outlet opening connected to the wiper, the outlet opening including an aperture, the aperture being directed toward the interior windshield surface of the car, and an elongated body extending between the inlet opening and the outlet opening,
wherein the pump is in fluid communication with the elongated body of the conduit, the pump being configured to suction the water vapor stored in the second portion of the interior storage area of the water tank, and to pump the suctioned water vapor toward the outlet opening of the conduit such that the suctioned water vapor can be directed toward the interior windshield surface of the car via the aperture included in the outlet opening of the conduit.

2. (canceled)

3. The interior windshield wiper system as recited in claim 1, wherein the wiper is configured to move horizontally across the interior windshield surface.

4. The interior windshield wiper system as recited in claim 1, wherein the wiper is configured to move vertically across the interior windshield surface.

5. The interior windshield wiper system as recited in claim 1, wherein the wiper is configured to move in an arc path across the interior windshield surface.

6. The interior windshield wiper system as recited in claim 1, wherein the wiper is configured to move in a circular pattern across the interior windshield surface.

7-12. (canceled)
